(19) United States
(12) Patent Application Publication
(10) Pub. No.: US 2023/0253875 A1
(43) Pub. Date: Aug. 10, 2023

(54) TWO-WAY AC POWER CONVERSION DEVICE

(71) Applicants: Yu HSU, Taoyuan City (TW); Guei-Cheng HU, Taoyuan City (TW)

(72) Inventors: Yu HSU, Taoyuan City (TW); Guei-Cheng HU, Taoyuan City (TW)

(21) Appl. No.: 18/088,796

(22) Filed: Dec. 27, 2022

(30) Foreign Application Priority Data
Dec. 29, 2021 (TW) 110149239

(51) Int. Cl. H02M 1/36; H02M 5/04

(52) U.S. Cl. CPC H02M 1/36; H02M 5/04

(57) ABSTRACT

The present invention provides a two-way power conversion device comprising a power conversion module and a digital control module. The power conversion module sets a first AC power to be input or output according to a control signal. The digital control module comprises a phase-locked loop circuit and a control unit. The phase-locked loop circuit detects the first AC power to be input or output and generate a real-time voltage signal having an amplitude component and an angular velocity component. The control unit sets the control signal according to the amplitude components and at least one amplitude variation obtained in different switching cycles. Wherein the control unit calculates said at least one amplitude variation according to the amplitude components obtained in different switching cycles, and the power conversion module to stop inputting or outputting the first AC power when said at least one amplitude variation is abnormal.

### CROSS REFERENCE TO RELATED APPLICATION

The present application claims priority to Taiwan patent application Serial No. 110149239 filed on Dec. 29, 2021 the entire content of which is incorporated by reference to this application.

### BACKGROUND OF THE INVENTION

### 1. Field of the Invention

The present invention pertains to a two-way AC power conversion device, more specifically to a two-way AC power conversion device which can cut off a device under test at any time.

### 2. Description of the Prior Art

Traditionally, if a device under test (DUT) needs to be cut off/disconnected from an AC power conversion device when the AC power conversion device is drawing current from the DUT, it is necessary to set the current drawn by the AC power conversion device to zero in the first place, then the DUT can safely be disconnected from the AC power conversion device. If the DUT is randomly disconnected from the AC power conversion device, the AC power conversion device will often trigger a protection mechanism and not be able to restart quickly. In one example, if the DUT is disconnected from an output terminal of the AC power conversion device randomly, the AC power conversion device will try to draw current from the output terminal which is already formed an open circuit, since the AC power conversion device cannot immediately determine that the DUT has been disconnected from the output terminal. At this time, the output terminal of the AC power conversion device may be subjected to abnormally high voltage. In order to prevent the AC power conversion device from being damaged, the traditional AC power conversion device will directly trigger the protection mechanism. Once the protection mechanism is triggered, even if the DUT has been connected again, the traditional AC power conversion device may need to go through certain steps of inspection before turning off the protection mechanism, so that the traditional AC power conversion device cannot resume the work of drawing current from the DUT quickly.

Accordingly, the industry needs a new AC power conversion device that can effectively protect internal components without entering a protection mechanism when the DUT is disconnected. Moreover, when the DUT is connected again, the AC power conversion device have to resume its work of drawing the current from the DUT quickly, increasing the flexibility of adjusting the DUT at any time.

### SUMMARY OF THE INVENTION

The present invention provides a two-way AC power conversion device, which can more sensitively determine whether a device under test is cut off from the output terminal. When the DUT is disconnected from the output terminal of the two-way AC power conversion device randomly, the two-way AC power conversion device can immediately aware and stop inputting or outputting AC power without entering a protection mechanism and can effectively protect internal components.

The present invention provides a two-way power conversion device for inputting or outputting a first AC power, the two-way AC power conversion device comprises a power conversion module and a digital control module. The power conversion module sets the first AC power to be input or output according to a control signal. The digital control module comprises a phase-locked loop circuit and a control unit. The phase-locked loop circuit is electrically connected to the power conversion module, and is used to detect the first AC power to be input or output and generate a real-time voltage signal. The real-time voltage signal has an amplitude component and an angular velocity component. The control unit is electrically connected to the power conversion module and the phase-locked loop circuit, and the control unit sets the control signal according to the amplitude components and at least one amplitude variation obtained in different switching cycles. Wherein the control unit calculates said at least one amplitude variation according to the amplitude components obtained in different switching cycles, and the control signal instructs the power conversion module to stop inputting or outputting the first AC power when the control unit determines that the amplitude component or said at least one amplitude variation is abnormal.

In some embodiments, wherein the control unit inspects the amplitude variation of each of the consecutive switching cycles, and the control unit determines said at least one amplitude variation is abnormal when the amplitude variations of the consecutive switching cycles are greater than a first threshold value. Besides, the control unit inspects the amplitude variation of each of the consecutive switching cycles, and the control unit determines said at least one amplitude variation is abnormal when the amplitude variations of the consecutive switching cycles are not greater than a second threshold value. Moreover, wherein the control signal indicates a duty ratio of the power conversion module, the control unit sets the control signal to instruct the power conversion module to stop inputting or outputting the first AC power when the control unit determines that the duty ratio is greater than a third threshold value.

In some embodiments, a phase detector of the phase-locked loop circuit performs Park transformation on the real-time voltage signal to obtain the amplitude component and the angular velocity component. Besides, the power conversion module draws the first AC power from a device under test through an output terminal, or supplies the first AC power to the device under test through the output terminal.

To sum up, the two-way AC power conversion device provided by the present invention utilizes a phase-locked loop circuit to lock the first AC power to be input or output, and determines whether the device under test is cut off from its output terminal by the amplitude component of the real-time voltage signal. When the device under test is disconnected from the output terminal randomly, the two-way AC power conversion device can immediately aware and stop inputting or outputting AC power without entering a protection mechanism and can effectively protect internal components.

### BRIEF DESCRIPTION OF THE APPTERMINALED DRAWINGS

FIG. 1 illustrates a block diagram of a two-way AC power conversion device according to an embodiment of the present invention.

FIG. 2 illustrates a schematic diagram showing an AC voltage.

### DETAILED DESCRIPTION OF THE INVENTION

The features, targetions, and functions of the present invention are further disclosed below. However, it is only a few of the possible embodiments of the present invention, and the scope of the present invention is not limited thereto; that is, the equivalent changes and modifications done in accordance with the claims of the present invention will remain the subject of the present invention. Without departing from the spirit and scope of the invention, it should be considered as further enablement of the invention.

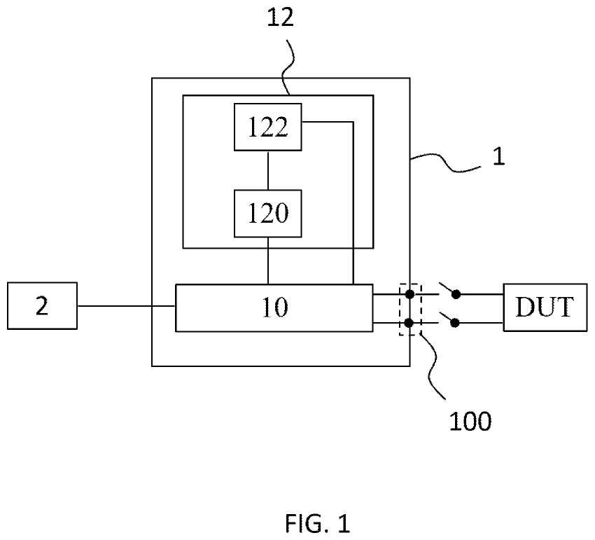

Please refer to FIG. 1. FIG. 1 illustrates a block diagram of a two-way AC power conversion device according to an embodiment of the present invention. As shown in FIG. 1, the two-way AC power conversion device 1 is electrically connected between an external power source 2 and a device under test (DUT), and is used to transmit AC power (first AC power) with the DUT. In practice, the external power source 2 can be a commercial power source or other voltage sources, and the DUT, applied to the two-way AC power conversion device 1, is not limited to be a load or a voltage source. In one example, when the DUT is a load, the two-way AC power conversion device 1 can provide AC power to drive the DUT. And when the DUT is a voltage source, the two-way AC power conversion device 1 can draw AC power from the DUT, so that the AC power provided by the DUT can be fed into the external power source 2. That is to say, the two-way AC power conversion device 1 does not limit the transmission direction of the AC power, and the AC power can be input to or output from the two-way AC power conversion device 1.

The two-way AC power conversion device 1 comprises a power conversion module 10 and a digital control module 12, and the digital control module 12 comprises a phase-locked loop (PLL) circuit 120 and a control unit 122. The power conversion module 10 has an output terminal 100, and the output terminal 100 is used to electrically connect the DUT. In one example, the output terminal 100 and the DUT may be connected via a busbar. In addition, the control unit 122 can be electrically connected to the phase-locked loop circuit 120 and the power conversion module 10 respectively, and can generate a control signal to set the first AC power to be input or output by the power conversion module 10. The control signal can be a pulse width modulation (PWM) signal, and the control unit 122 can set various parameters of AC voltage or AC current output by the power conversion module 10 by determining the duty ratio of the PWM signal.

In practice, there can be a phase detector in the phase-locked loop circuit 120. When the output terminal 100 is connected to the DUT, the phase detector should be able to lock the AC voltage or AC current transmitted between the power conversion module 10 and the DUT. For example, assuming that the power conversion module 10 is set to draw current from the DUT, and when the phase detector locks the AC voltage, the phase-locked loop circuit 120 can generate a real-time voltage signal according to the locked AC voltage. In one example, the real-time voltage signal generated by the phase-locked loop circuit 120 can be used as a means to determine whether the DUT works normally. That is to say, when the phase detector successfully locks the AC voltage (and generates the real-time voltage signal), the control unit 122 can determine that the DUT has been found in the system. In addition, the phase-locked loop circuit 120 can perform Park transformation on the real-time voltage signal to obtain an amplitude component and an angular velocity component of the real-time voltage signal. Person having ordinary skill in the art should be able to understand how the phase-locked loop circuit 120 works, and will not be repeated in this embodiment. In one example, the phase-locked loop circuit 120 can obtain a real-time voltage signal in each switching cycle, so that the control unit 122 can calculate the difference between the amplitude components of the real-time voltage signal obtained in two consecutive switching cycles. The difference between two amplitude components corresponding to consecutive two switching cycles can be defined as an amplitude variation. In practice, the control unit 122 can record the corresponding N-1 amplitude variations corresponding to the real-time voltage signal obtained in N consecutive switching cycles, and can set the control signal according to the N-1 amplitude variations.

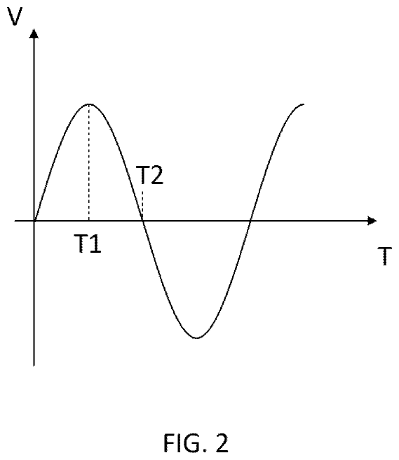

For example, suppose that the power conversion module 10 is set to draw current from the DUT, and the connection between the output terminal 100 and the DUT is suddenly interrupted, causing the DUT to cut off from the output terminal 100. Since the two-way AC power conversion device 1 and the DUT are transmitting AC power, the AC voltage may be close to the demonstrate (situation 1) or close to zero voltage (situation 2) when the DUT is disconnected from the output terminal 100. The following paragraphs will discuss said two situations and demonstrate how the two-way AC power conversion device 1 works. Please refer to FIG. 1 and FIG. 2 together, FIG. 2 is a schematic diagram of an AC voltage. As shown in the figures, assuming that the DUT is disconnected from the output terminal 100 at time T1, the AC voltage is close to the peak voltage. First, the control unit 122 can know from the real-time voltage signal (the previous switching cycle and the current switching cycle) that the amplitude variation suddenly becomes abnormally large. For example, the AC voltage rapidly drops from the peak so that the amplitude variation is greater than a preset first threshold value. In practice, after the control unit 122 determines that the amplitude variation is abnormal, the control signal can be quickly adjusted, so that the control signal instructs the power conversion module 10 to stop inputting or outputting the first AC power. For example, the control unit 122 can adjust the control signal to set the duty ratio to zero, so that the output terminal 100 of the power conversion module 10 maintains zero voltage without inputting or outputting the first AC power.

The present embodiment does not limit the exact value of the first threshold value, and person having ordinary skill in the art can understand that the first threshold value can be determined according to the transmitted AC voltage. On the other hand, the control unit 122 does not necessarily adjust the control signal immediately based on only a single amplitude variation occurring abnormally. For example, the control unit 122 may also determine whether the amplitude variations may be abnormal from the real-time voltage signals of a plurality of consecutive adjacent switching cycles. In an embodiment, when the control unit 122 learns that at least six consecutive amplitude variations are all greater than the preset first threshold value, the control unit 122 can determine that the DUT has been disconnected from the output terminal 100.

In another example, assuming that the DUT is disconnected from the output terminal 100 at time T2, since the AC voltage at time T2 is close to zero, the current input or output by the output terminal 100 is also close to zero (can be considered as a current zero point). Taking the traditional AC power conversion device as an example, the traditional AC power conversion device cannot immediately determine whether the DUT is disconnected, which may easily lead to misjudgment. In particular, traditional AC power conversion devices use digital measurement of current, which has errors such as noise interference, so it is difficult to determine whether the small value of current detected around the current zero point is actually due to the current zero point. In other words, when the DUT is disconnected around the current zero point, the traditional AC power conversion device cannot immediately trigger the protection mechanism. In contrast, the amplitude component of this embodiment is a value that has been separated from the angular velocity component (phase) by Parker transformation, so that the control unit 122 can quickly see whether there is a change in the voltage amplitude. Accordingly, when the DUT is disconnected from the output terminal 100 at time T2, the control unit 122 of this embodiment can also determine whether an abnormality occurs based on the difference of amplitude variation and immediately adjust the control signal, so that the control signal can instruct the power conversion module 10 to stop inputting or outputting the first AC power.

The above means using the amplitude variation is applicable to the situation where the input or output AC voltage of the power conversion module 10 changes greatly. If the input or output AC voltage of the power conversion module 10 changes little, the control unit 122 can use the amplitude component to determine whether the DUT is cut off. In one example, since the voltage peak value of the input or output AC voltage of the power conversion module 10 is known, the present embodiment can refer to the voltage peak value to set another threshold value (a second threshold value). In practice, the second threshold is not necessarily equal to the peak voltage but may be slightly smaller than the peak voltage, which is not limited in this embodiment. In practice, assume that the power conversion module 10 is set to draw current from the DUT, and the phase detector of the phase-locked loop circuit 120 has locked the real-time voltage signal to obtain the amplitude component and the angular velocity component. At this time, the control unit 122 can determine whether the DUT is disconnected according to whether one or more amplitude components are lower than the second threshold value. For example, the control unit 122 may record the amplitude components of multiple consecutive switching cycles. When the amplitude components of multiple consecutive switching cycles are continuously smaller than the second threshold value, the control unit 122 can determine that the DUT has been disconnected. As mentioned above, the amplitude component of this embodiment is a value that has been separated from the angular velocity component (phase) by Parker transformation, so that even if the AC voltage changes little, the control unit 122 can quickly determine whether the DUT is disconnected. Similarly, when the control unit 122 determines that the DUT has been disconnected, the control unit 122 can adjust the control signal to set the duty ratio to zero, so that the output terminal 100 of the power conversion module 10 can stay at zero voltage and no inputting or outputting AC power.

It is worth mentioning that since the output terminal 100 is usually connected with a capacitor. For example, the capacitor can be connected across two ends of the output terminal 100, and the capacitor may also cause a voltage spike or surge after the DUT is cut off and may further rise up the voltage at the output terminal 100. This embodiment also designs a mechanism to avoid the voltage spike or surge and release the stored energy of the capacitor. For example, assuming that the power conversion module 10 is set to draw the current from the DUT, in order to avoid the voltage spike or surge caused by the disconnection of the DUT, the power conversion module 10 of this embodiment can preset the upper limit of the duty cycle to a third threshold value. For example, the upper limit of the duty cycle can be set to 0.95. That is to say, when the control unit 122 determines that the duty cycle of the power conversion module 10 is greater than the third threshold value, the possible reason for the duty cycle being greater than the third threshold value is that the DUT is cut off while the AC voltage is close to the peak value. Therefore, the control unit 122 can directly adjust the control signal to set the duty cycle to zero, so that the output terminal 100 of the power conversion module 10 maintains zero voltage without inputting or outputting AC power. In addition, the digital control module 12 can also monitor the voltage and current value of the output terminal 100, and the power conversion module 10 will maintain zero voltage for a period of time until the digital control module 12 determine that the capacitor has released the stored energy.

On the other hand, although the above is an example in which the power conversion module 10 is set to draw the current from the DUT, the power conversion module 10 can also supply power to the DUT. That is to say, the control unit 122 can determine whether there is an abnormal condition, such as the amplitude variation greater than the first threshold, the amplitude component less than the second threshold, and the duty cycle of the power conversion module 10 greater than the third threshold, no matter what power transmission direction is. Even though the power conversion module 10 is used to supply power to the DUT, the control unit 122 can still determine whether the DUT is disconnected according to the above embodiment.

As can be seen from the above, since the control unit 122 uses the amplitude component of the real-time voltage signal locked by the phase-locked loop circuit 120 to determine whether the DUT is disconnected or not, the control unit 122 can reduce the influence of the voltage phase. The two-way AC power conversion device 1 can quickly adjust the control signal to set the duty cycle to zero before the voltage rise up when the DUT is disconnected from the output terminal 100, so that the two-way AC power conversion device 1 will not trigger the protection mechanism since there is no the abnormally high voltage at the output terminal 100. Because the two-way AC power conversion device 1 does not trigger the protection mechanism, the two-way AC power conversion device 1 can quickly resume operation when the DUT is reconnected to the output terminal 100.

To sum up, the two-way AC power conversion device provided by the present invention utilizes a phase-locked loop circuit to lock the first AC power to be input or output, and determines whether the device under test is cut off from its output terminal by the amplitude component of the real-time voltage signal. When the device under test is disconnected from the output terminal randomly, the two-way AC power conversion device can immediately aware and stop inputting or outputting AC power without entering a protection mechanism and can effectively protect internal components.

What is claimed is:

1. A two-way power conversion device for inputting or outputting a first AC power, comprising:
a power conversion module setting the first AC power to be input or output according to a control signal; and
a digital control module, comprising:
a phase-locked loop circuit, electrically connected to the power conversion module, for detecting the first AC power to be input or output and generating a real-time voltage signal, having an amplitude component and an angular velocity component; and
a control unit, electrically connected to the power conversion module and the phase-locked loop circuit, setting the control signal according to the amplitude components and at least one amplitude variation obtained in different switching cycles;
wherein the control unit calculates said at least one amplitude variation according to the amplitude components obtained in different switching cycles, and the control signal instructs the power conversion module to stop inputting or outputting the first AC power when the control unit determines that the amplitude component or said at least one amplitude variation is abnormal.

2. The two-way power conversion device according to claim 1, wherein the control unit inspects the amplitude variation of each of the consecutive switching cycles, and the control unit determines said at least one amplitude variation is abnormal when the amplitude variations of the consecutive switching cycles are greater than a first threshold value.

3. The two-way power conversion device according to claim 1, wherein the control unit determines the amplitude variation of each of the consecutive switching cycles, and the control unit determines said at least one amplitude variation is abnormal when the amplitude variations of the consecutive switching cycles are not greater than a second threshold value.

4. The two-way power conversion device according to claim 1, wherein the control signal indicates a duty ratio of the power conversion module, the control unit sets the control signal to instruct the power conversion module to stop inputting or outputting the first AC power when the control unit determines that the duty ratio is greater than a third threshold value.

5. The two-way power conversion device according to claim 1, wherein a phase detector of the phase-locked loop circuit performs Park transformation on the real-time voltage signal to obtain the amplitude component and the angular velocity component.

6. The two-way power conversion device according to claim 1, wherein the power conversion module draws the first AC power to a device under test through an output terminal, or supplies the first AC power to the device under test through the output terminal.
